(19) United States
(12) Patent Application Publication
(10) Pub. No.: US 2007/0034678 A1
(43) Pub. Date: Feb. 15, 2007

(54) Configurable RFID apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 11/200,348

(22) Filed: Aug. 9, 2005

(51) Int. Cl. G06F 17/00; G06K 5/00; G06K 19/00

(52) U.S. Cl. 235/375; 235/380; 235/487

(57) ABSTRACT

The invention described herein represents a significant improvement in creation and utility of RFID systems by creating a freeform field where readable data can be printed or written. Processes associated with the invention may comprise the following steps; depositing a plurality of antennae upon a substrate sheet wherein each respective antenna is capable of producing a respective RFID signature, storing in a database (or memory) the data describing the respective RFID signatures and a map of physical positions on the sheet of each associated respective antenna, the writing of indicia on the sheet of antennae that alters the properties of RFID signatures of some antennae on the sheet, using RFID to sense antennae on the sheet, comparing sensed antennae information to possible antennae information in the database to produce an altered antennae map of the sheet, displaying of the altered antennae map, storing of the altered antennae map in the database, a character recognition step where the altered antennae map is compared with a database of characters to convert the map into alphanumeric or other indicia data, displaying of the alphanumeric or other indicia data, storing of the alphanumeric or other indicia data in the database, comparing the data to a database of possible data for the purpose of controlling processing of the sheet and/or a physical object associated with the sheet; and/or whereby a writing on the sheet is used to control processing of the sheet.

### BACKGROUND FIELD OF INVENTION

Packaging and containers are among the wide variety of applications where RFID (radio frequencies identification) tags are currently being used by the many hundreds of millions. The highest volumes of tags generally comprise a passive antenna integrated within a product or packaging which in operation, can be detected at points within the product distribution cycle. When data associated with the product is to be accessed, the product tag is caused to resonate a signature that is distinguishable from others when compared to a database of resonation signatures. The matching signature within the database then is used to call up details from the database about the product associated with the sensed tag signature. Active RFID tags are also known which operate similarly to passive RFID tags except that they are integrated with a transmitter which emits a signal that can be sensed.

### BACKGROUND-DESCRIPTION OF PRIOR INVENTION

The vast majority of prior art relates to passive RFID tag systems where a product has a single tag associated with it. The single product tag will stay with the product through a portion of the distribution cycle and generally not be altered during the distribution cycle except possibly when the product moves out of the distribution system (is purchased by a customer) at which time the RFID tag may be deactivated in some instances. Some prior art describes RFID tags that can be altered by a worker in the product distribution cycle to customize information about the product. For example, U.S. Pat. No. 4,889,961(Carlson) describes a process whereby a worker draws a line with a conductive material which completes a circuit as a mechanism to customize and alter the information communicated by an RFID tag. Similarly, U.S. Pat. No. 6,805,291(Chhatpar et al) describes a process whereby a worker can utilize a writing instrument such as a pencil, printer, and/or eraser to connect and disconnect circuits associated with an RFID tag to modify the RFID signature of the tag. The process of modifying an RFID circuit using a writing instrument such as a pencil, eraser, and/or printer being further described in U.S. Pat. No. 6,840,444 (Pierce et al), U.S. Pat. No. 6,869,020 (Foth et al), and U.S. Pat. No. 6,869,021 (Foth et al). The prior art described in this paragraph generally representing examples of configurable or reconfigurable RFID tags using connectable and disconnectable contacts and associated circuits whereby individual tags are configured or reconfigured to represent data.

### BRIEF SUMMARY

The invention described herein represents a significant advancement in configurable and reconfigurable RFID freeform sheets. Freeform sheets are a novel basis for enabling hand written or printed text to be read using RFID techniques according to a process such as the following preferred embodiment. A plurality of individual RFID tags is arrayed on a substrate sheet. Each tag in the plurality has a unique signature, an associated database identifier, and a known positional relationship to the other unique tags on the sheet. Each unique identifier is user configurable so as to be turned off, retuned, or turned on. Using a writing instrument such as either a pen, an eraser, or a printer, the user interacts with the sheet to configure or reconfigure some or all of the unique tags for example by writing a word on the sheet. The sheet is then read using RFID techniques such that each individual tag that produces a readable signal is sensed, registered, and plotted on a map of the sheet using the predetermined positional relationships of the individuals tags in the array. This map is then interpolated using automatic charter recognition software to convert the map into alpha numeric data which is stored in a database or used in determining the routing or processing of the sheet and/or the article or product associated with the sheet. Thus user alterable status of individual unique FRID tags on the freeform sheet forms the basis of communicating data in the form of a map of altered and unaltered individual unique tags that are interpolated using character recognition software into meaningful hand written words, printed words, alphanumeric characters, diagrams, or indicia that can be stored in a database, and or used for processing the sheet and/or a person or product associated with the sheet.

Thus the present invention offers a significant advancement in the ability to communicate an unlimited range of information on a single freeform RFID readable sheet.

### OBJECTS AND ADVANTAGES

Accordingly, several objects and advantages of the present invention are apparent. It is an object of the present invention to provide a means to reliably and inexpensively communicate a very wide range information using an RFID technique.

It is an object of the present invention to provide an RFID freeform field where data can be written in by hand and automatically be stored in a database as alphanumeric data associated with an object, a product, or a person.

It is an object of the present invention to provide an RFID freeform field where data can be printed in and automatically stored in a database as alphanumeric data associated with an object, a product, or a person.

It is an object of the present invention to provide an RFID freeform field where data can be erased by hand and automatically be altered in a database as alphanumeric data associated with an object, a product, or a person.

Further objects and advantages will become apparent from the enclosed figures and specifications.

### DRAWING FIGURES

FIG. 1a illustrates a sheet of exposed arrayed individual unique RFID devices each having a unique signature.

FIG. 1b illustrates the sheet of FIG. 1a with a word printed thereon.

FIG. 2a illustrates a letter hand printed on the sheet of FIG. 1a.

FIG. 2b illustrates an RIFD sensed map of the letter of FIG. 2a and the sensing process.

FIG. 3a illustrates a sheet of covered arrayed individual unique RFID devices each having a unique signature.

FIG. 3b illustrates the sheet of FIG. 3a with a word printed thereon.

FIG. 4a illustrates a letter hand printed on the sheet of FIG. 3a.

FIG. 4b illustrates an RIFD sensed map of the letter of FIG. 4a and the sensing process.

FIG. 5a illustrate a sheet of arrayed RFID tags each having a unique signature with printed indicia and a selection made.

FIG. 5b illustrates a side view of a small section of FIG. 1a.

FIG. 5c illustrates a side view of a small section of FIG. 1b.

FIG. 5d illustrates a side view of a small section of FIG. 3a.

FIG. 5e illustrates a side view of a small section of FIG. 3b.

FIG. 5f illustrates a side view of a small section of FIG. 3a in an alternate embodiment.

FIG. 5g illustrates a side view of a small section of FIG. 1b in an alternate embodiment.

### Detailed Description of the Invention

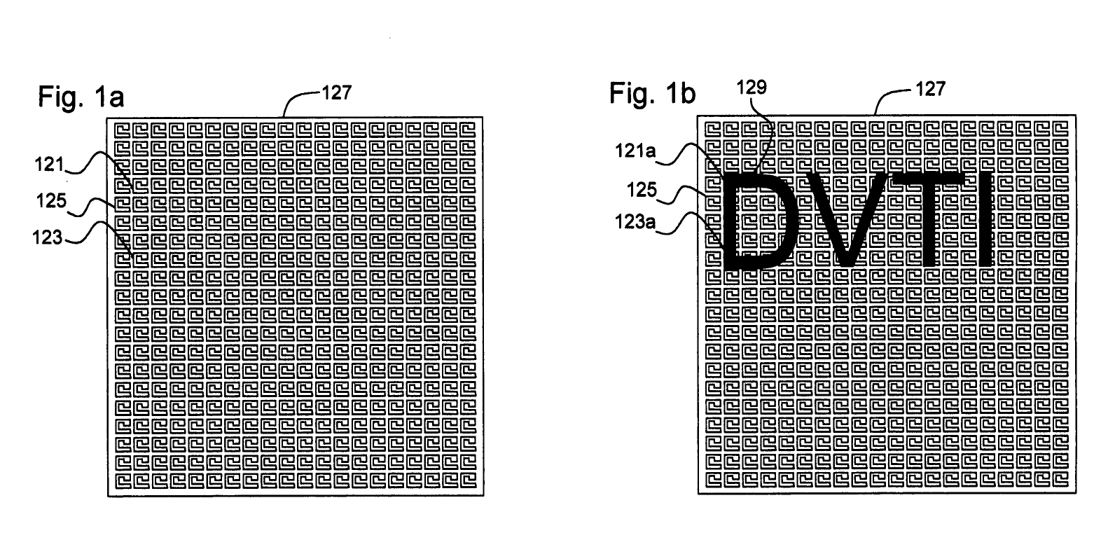

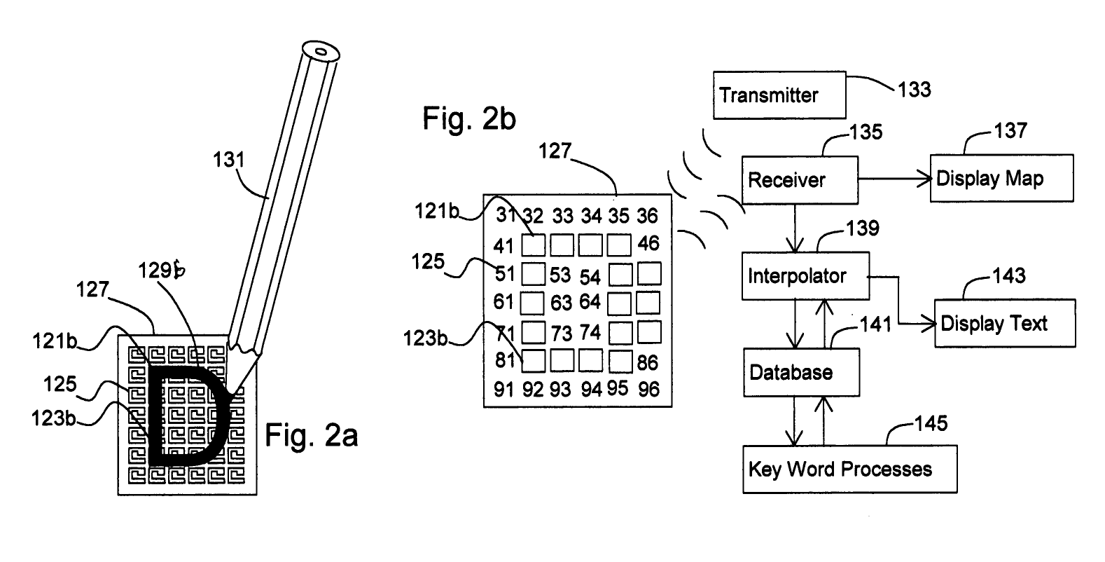

FIG. 1a illustrates a sheet of exposed arrayed individual RFID devices each having a unique signature. A first substrate 127 comprises a sheet such as paper upon which is affixed or otherwise deposited an array of RFID antennae such as a first antenna 121 which in operation produces a first RFID signature, a second antenna 123 which in operation produces a second RFID signature, and a third antenna 125 which in operation produces a third RFID signature. All of the dozens of individual RFID antenna of FIG. 1a are capable of producing a respective individual RFID signature that differentiates it from others on the sheet. As described in FIG. 2b, the positions of each respective transmitting antenna is known and stored its location on the sheet substrate together with its signature is stored in a database which is used in reading and interpreting changes made on the sheet. The 121, 123, and 125 comprising a plurality of devices on a substrate including a first device capable of producing a first signature, a second device capable of producing a second signature, and a third device capable of producing a third signature.

FIG. 1b illustrates the sheet of FIG. 1a with a word printed thereon. In a printing process, an RF interfering or otherwise electrically conducting ink is printed upon the surface of the first substrate sheet 127 including a first letter “D” 129. In a first alternative approach, the ink is deposited directly upon and has electrical communication with antennae and/or associated circuitry upon which it is printed so as to effectively short circuit or modify their respective RF signatures while not having electrical communication with antennae and/or associated circuitry upon which it is not printed and not altering their signatures. In a second alternative approach, the ink has an RF signal interfering or blocking effect on antennae and/or antennae circuitry upon which it is printed while not having an RF signal interfering or blocking effect on antennae and/or antennae circuitry upon which it is not printed. In ether case, the RFID signature of each antenna covered by ink in FIG. lb is altered from its original respective signature when it was not covered by ink as in la. Thus a first altered antenna 121a produces either no signature or an altered signature as compared to the first antenna 121 of FIG. 1a and a second altered antenna 123a produces either no signature or an altered signature as compared to the second antenna 123 of FIG. 1a. Note that the third RFID signature produced by the third antenna 125 is not altered by the printing process since it is neither in electrical contact with the ink nor covered by RF interfering ink. The process described in FIG. 2b will map the altered antennae compared to the unaltered antennae as a step to reading the words that have been printed upon the substrate sheet. It should be noted that the size of the antennae compared to the size of the sheet and the size of the print can be altered in scale such that a single letter may cover dozens of antennae to increase the resolution when read in the process of FIG. 2b. Suitable inks and printing processes are know in the prior art some of which are reference in the above Prior Invention section.

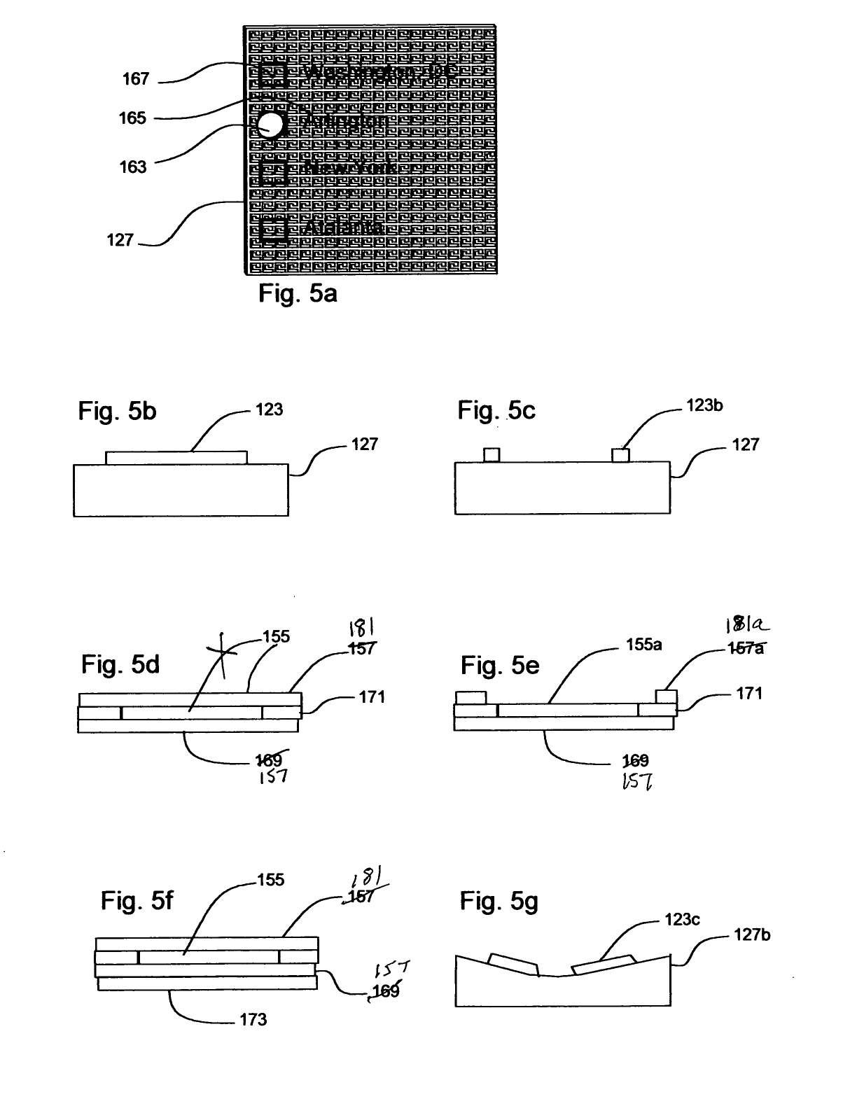

FIG. 2a illustrates a letter hand printed on the sheet of FIG. 1a. A writing instrument such as a pencil contains an electrically conductive or RF interfering composite including for example graphite which may also be erasable. Suitable hand writing instruments such as pencils, erasers, pens, and styluses are described in the prior art some of which is referenced in the above Prior Invention section. For antennae upon which the pencil writes, the RFID signatures are altered as described in FIG. 1b. For antennae upon which the pencil does not write, the antennae RFID signatures are unaltered from those described in FIG. 1a and in a database describing signatures and signature according to FIG. 2b. Alternately, to alter the signature of select antennae, the writing instrument can be a stylus used to break the antennae or associated circuitry according to FIGS. 5c and 5g. Thus a first hand written letter “D” 129b is written upon the substrate sheet 127 whereby the RF signatures of covered (or partially covered) antennae are altered such as first hand instrument altered antenna 121b, and second hand instrument altered antenna 123b. Those antennae with altered signatures no longer match the signatures of the original sheet of FIG. 1a and as further described in the reading described in FIG. 2b reading and interpolating processes. Signatures of antennae that were not written on such as the third antenna 125 are not altered and are still capable of producing their original RFID signatures.

FIG. 2b illustrates an RIFD sensed map of the letter “D” of FIG. 2a and the RFIfD sensing and interpreting processes. After being written on with a writing instrument or with a printer, the signatures of altered antennae and/or associated circuitry will not match those original signatures in a database 141. Each antenna that can be read according to its original signature has a known signature and a known positional relationship such as the individual respective double-digit numbers in FIG. 2b. In operation, an RF transmitter 133 emits energy that causes the unaltered antennae on the substrate sheet 127 to emit their specific signatures which are received by an RFID receiver 135, the signatures are compared to a map in the database to form an altered signature map which can be displayed 137. The map comprising spots (or pixels) on the sheet where received antennae signatures match those in the database such as the double-digit numbers including third antenna 125. The map also comprising spots (or pixels) where the signatures of antennae at specific frequencies have not been received such as the first altered antenna 121b and the second altered antenna 123b. Such altered antennae being mapped as the printed or written indicia that was placed upon the sheet substrate in FIGS. 1b, and/or 2a. In order to convert the altered sheet map to data, an interpolator 139 compares the map to a database of known alphanumeric characters or other indicia to discern what the map says. Once the alphanumeric characters are interpolated, they can be stored in the database or displayed as text 143 on a screen. A vast number of processes 145 such as shipping, or distribution instructions can be executed by comparing a keyword list in the database to words that are interpolated from the sheet and stored in the database. For example, if the words written contain a zip code, keyword processes can automatically route a package associated with the sheet to the appropriate zip code written thereon. Thus a very wide range of hand written or printed information can be converted to executable data using the RFID technique described herein. The transmitter, receiver, database, and keyword processes being well known in the prior art. The interpolator 139 being virtually identical to those employed for optical character recognition (OCR) processes except with the advantage that whereas optical scanning of the sheet requires that an optical scanner be in a certain close tolerance proximity to the sheet, the RFID scanning technique can be employed from a far greater distance and tolerance than can optical scanning. The character recognition process herein utilizing a directory of indicia, alphanumeric characters, words, symbols, patterns, or physical relationships that can be used to compare against the sensed map for the purpose of identifying recognizable characters or content. Thus steps of the present invention may include; depositing a plurality of antennae upon a substrate sheet wherein each respective antenna is capable of producing a respective RFID signature, storing in a database (or memory) the data describing the respective RFID signatures and a map of physical positions on the sheet of each associated respective antenna, the writing of indicia on the sheet of antennae that alters the properties of RFID signatures of some antennae on the sheet, using RFID to sense antennae on the sheet, comparing sensed antennae information to possible antennae information in the database to produce an altered antennae map of the sheet, displaying of the altered antennae map, storing of the altered antennae map in the database, a character recognition step where the altered antennae map is compared with a database of characters to convert the map into alphanumeric or other indicia data, displaying of the alphanumeric or other indicia data, storing of the alphanumeric or other indicia data in the database, comparing the data to a database of possible data for the purpose of controlling processing of the sheet and/or a physical object associated with the sheet; and/or whereby a writing on the sheet is used to control processing of the sheet.

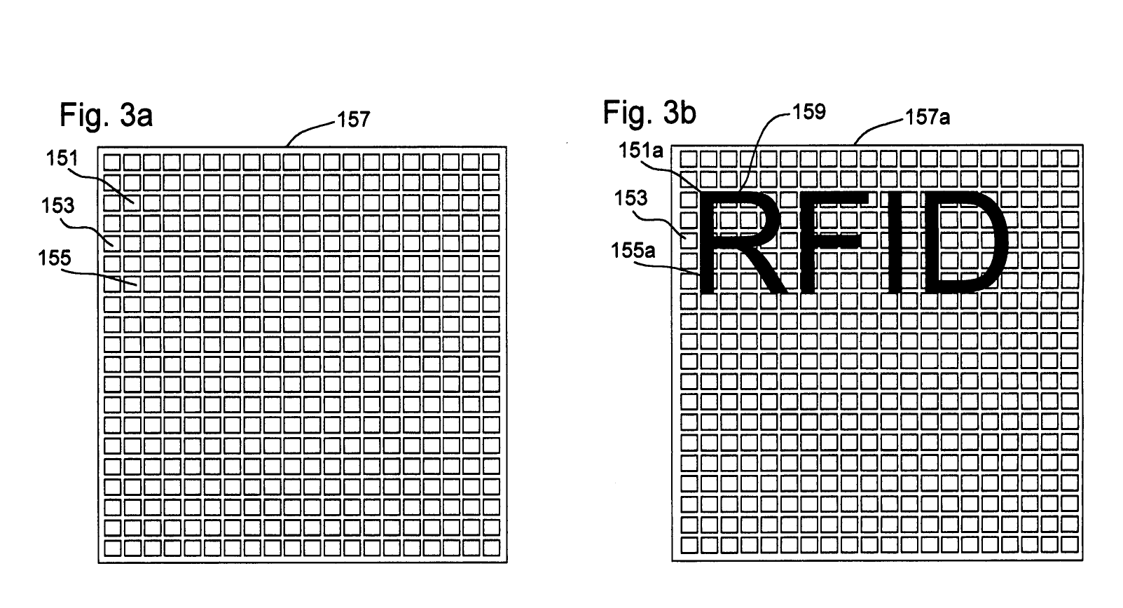

FIG. 3a illustrates a sheet of covered arrayed individual unique RFID devices each having a unique signature. A blocked antennae array sheet 157 is identical to the substrate sheet 127 of FIG. la except that all of the antennae are blocked from producing their respective RF signatures stored in the database as further described in FIGS. 5d, 5e, and 5f. A first blocked antenna 151, a second blocked RF antenna 155, and a third blocked antenna 153 are covered by a material such as a thin aluminum foil deposition so that their unique signatures can not be detected by the RFID process.

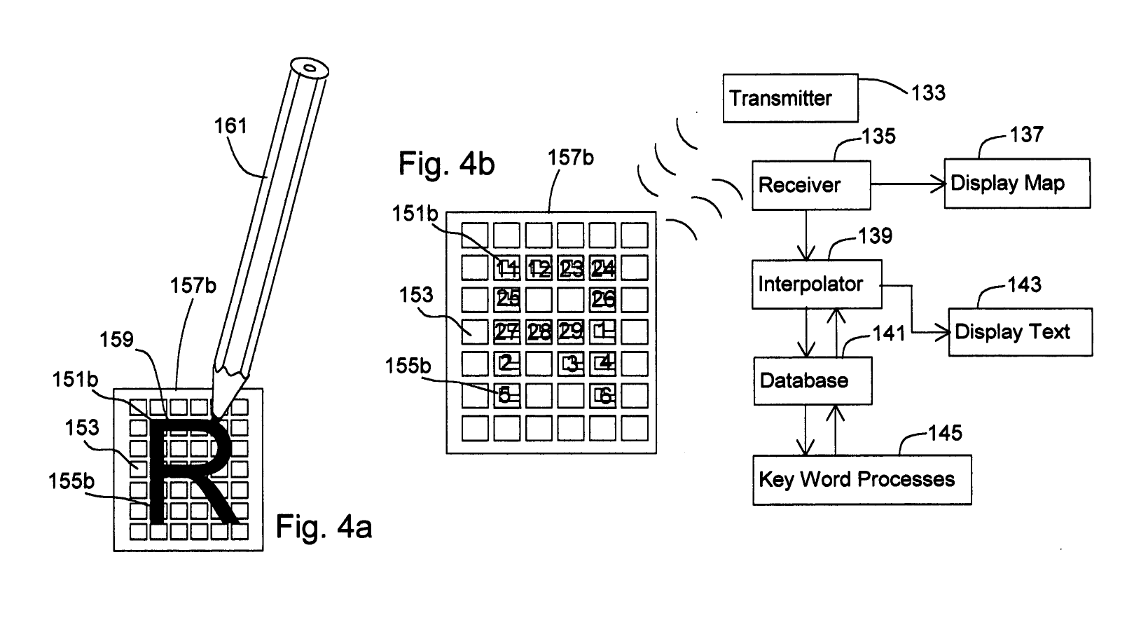

FIG. 3b illustrates the sheet of FIG. 3a with a word printed thereon. Indicia can be printed on the altered covered sheet 157a such as a printed “R” 159. When the indicia is printed upon the 157a, it destroys the blocking layer thereby exposing underlying antennae including a first exposed antenna 151a, and a second exposed antenna 155a. The exposure can be facilitated by a chemical process that destroys the ability of the blocking deposition from effectively blocking the RFID antennae signatures. Alternately, a mechanical process may be utilized such as is described in FIG. 4a. In either case, the blocking property of material covering antennae which are not printed on, is not changed by the printing process including third blocked antenna 153 which can not produce the RFID signature stored in memory.

FIG. 4a illustrates a letter hand printed on the sheet of FIG. 3a. A hand held writing instrument such as an alternate pencil 161 can be used to write on the sheet in a process that mechanically removes the RF interfering layer as illustrated in FIG. 5e to create altered blocked sheet 157b having the hand written letter “R” 159 written thereon. Thus alternate exposed first antenna 151 b is cleared to be able to produce its unique RF signature and alternate exposed second antenna 155b is cleared to be able to produce its unique RF signature. Similarly, all antennae that wee written upon are cleared to produce their respective RFID signatures which are stored in a database together with their respective positions on the substrate sheet. Note that blocked third antenna 153 can not produce its unique RFID signature. Similarly, all antennae that were not written upon, are still not able to produce their respective RFID signature.

FIG. 4b illustrates an RIFD sensed map of the letter of FIG. 4a and the sensing process. Exposed antennae are able to produce their individual respective RF signatures including the first unblocked antenna 151b, and the second unblocked antenna 155b.Unexposed antennae still remain blocked from producing their RFID signatures including the third blocked antenna 153. The processes of converting the altered antennae into meaningful data o control processes is the same as that described in FIG. 2b.

FIG. 5a illustrate a sheet of arrayed RFID tags each having a unique signature with printed indicia and a selection made. An example of an application of the present invention is a routing ticket for a passenger or merchandise. The ticket can have words printed upon it such as a first destination and selection boxes such as non-selected box 167 and selected box 163. The status of the ticket can be remotely sensed using RFID techniques known in the prior art. During the processing of the sensing and processing steps according to FIG. 2a, the area on the ticket which is perforated will be sensed as an altered part of the map since the antennae in that area have been physically removed or destroyed.

FIG. 5b illustrates a side view of a small section of FIG. 1a. The second antenna 123 may protrude above the surface of the substrate so as to be easily written upon such that indicia electrically communicates with it or it can easily be destroyed in the writing process as in FIG. 5c.

FIG. 5c illustrates a side view of a small section of FIG. 1b. The alternate first antenna 123b has been physically broken by the writing process (as compared to FIG. 5b) which alters or destroys its RF signature from that possible in FIG. 5b.

FIG. 5d illustrates a side view of a small section of FIG. 3a. The RF signature blocking layer 181 covers the blocked antennae including second blocked antenna 155. Between antennae may be a inert substrate 171.

FIG. 5e illustrates a side view of a small section of FIG. 3b. The second exposed antenna 115a can produce an RFI signal that can be read after the extracted blocking layer 181a has been removed in the writing step.

FIG. 5f illustrates a side view of a small section of FIG. 3a in an alternate embodiment. In some applications, blocking the RFID signal may require use of an additional bottom RF blocking layer 173 to insulate the antennae from producing signatures.

FIG. 5g illustrates a side view of a small section of FIG. 1b in an alternate embodiment. The compressed first antenna 123c has been physically broken by the writing process (as compared to FIG. 5b) which alters or destroys its RF signature from that possible in FIG. 5b. The physical shape was facilitated by an altered substrate 127a which comprises a material that compresses when written upon such that antennae thereon are altered in the writing or printing processes.

Operation of the Invention

Operation of the invention has been discussed under the above heading and is not repeated here to avoid redundancy.

Conclusion, Ramifications, and Scope

Thus the reader will see that the Configurable RFID Apparatus and Process of this invention provides a novel unanticipated, highly functional and reliable means for employing RFID techniques in a freeform RFID tag that comprises a plurality of smaller tags that can be used to capture as data a wide range of printed or written indicia which in turn can be used to drive an unlimited variety of processes.

While the above description describes many specifications, these should not be construed as limitations on the scope of the invention, but rather as an exemplification of a preferred embodiment thereof. Many other variations are possible for example:

The description herein illustrates the invention in a passive RFID tag, but it is understood to also be useful in active RFID tag systems.

A few applications are described herein but it should be understood that the applications of the present invention are virtually limitless.

Means of altering the readability of individual antenna signatures to achieve the ends of rendering an antenna to be either readable, unreadable, or readable with an altered signature have all been described herein using methods of communicating electrically with an antenna or circuits associated with an antenna, blocking or unblocking the ability of an antenna or circuits associated with an to produce an RF signal, or destrying the ability of an antenna or circuits associated with an to produce an RF signal. It is anticipated that other means are possible for achieving similar ends. Also, while the description herein focuses on interacting with the antenna as a means to produce an RF altered map, it is understood that any element such as a circuit which is in communication with an antenna can also be similarly altered to achieve identical ends.

What is claimed:

1. A process for communicating useful data comprising the steps of;
providing a plurality of devices on a substrate including a first device capable of producing a first signature, a second device capable of producing a second signature, and a third device capable of producing a third signature,
providing a data storage means that contains information describing the first signature and physical position on the substrate of the first device, the second signature and physical position on the substrate of the second device, and the third signature and physical position on the substrate of the third device,
altering the signature of at least one device with respect to at least one aspect selected from the group consisting of, blocking the signature, unblocking the signature, altering the ability to produce a signature, and altering the signature,
sensing the signatures present on the substrate, and comparing the sensed signatures to those in the data storage.

2. The process for communicating useful data of claim 1 wherein the comparing of sensed signatures to signatures in data storage is used to create a map of at least one selected from the group consisting of, altered device positions, and unaltered device positions.

3. The process for communicating useful data of claim 1 wherein information derived from the comparing of sensed signatures to signatures in data storage is used in a process that searches for at least one selected from the group consisting of, a recognizable character, recognizable indicia, recognizable pattern, and recognizable correlation with printed indicia on the substrate.

4. The process for communicating useful data of claim 1 wherein information derived from the comparing of sensed signatures to signatures in data storage is stored as data.

5. The process for communicating useful data of claim 1 wherein the first second and third devices are selected from the group consisting of, antennae, circuits, and RFID devices.

6. The process for communicating useful data of claim 1 wherein information derived from the comparing of sensed signatures to signatures in data storage is used in a process.

7. The process for communicating useful data of claim 1 the signatures are sensed remotely by a sensing process.

8. The process for communicating useful data of claim 1 wherein the sensing process is RFID.

9. The process for communicating useful data of claim 1 wherein the alterations were caused by a process selected from the group consisting of, writing with a hand help instrument, printing, erasing, and removing a piece.

10. The process for communicating useful data of claim 1 wherein the comparing of sensed signatures to signatures in data storage is used to create a map of at least one selected from the group consisting of, altered signatures, and unaltered signatures. is displayed and such map is displayed on a viewing device.

11. A device for communicating useful information comprising,
a substrate,
a first device capable of producing a first signature,
a second device capable of producing a second signature,
a third device capable of producing a third signature,
a data storage means
wherein the first device is on the substrate, the second device is on the substrate and the third device is on the substrate, and the data storage contains information describing the first signature and physical position on the substrate of the first device, the second signature and physical position on the substrate of the second device, and the third signature and physical position on the substrate of the third device.

12. The device for communicating useful information of claim 11 further comprising a signature alteration means selected from the group consisting of, a hand held instrument, and a printing instrument, wherein the signature of at least one device is altered with respect to at least one aspect selected from the group consisting of, blocking the signature, unblocking the signature, altering the ability to produce a signature, and altering the signature.

13. The device for communicating useful information of claim 12 further comprising a sensor to sense the signatures present on the substrate.

14. The device for communicating useful information of claim 13 further comprising an Interpolator for comparing the sensed signatures to those in the data storage, for the purpose of producing a map with features selected from the group consisting of, sensed unaltered device positions, and altered device positions.

15. The device for communicating useful information of claim 14 further comprising a directory in data storage of possible characters for use by the interpolator to compare the map with recognized characters and recognized content.

16. The device for communicating useful information of claim 15 wherein recognized characters are used to make a decision about how to perform a process.

17. The device for communicating useful information of claim 13 wherein information derived from the sensed signatures is stored in data storage.

17. The device for communicating useful information of claim 11 wherein the first second and third devices are selected from the group consisting of, antennae, circuits, and RFID devices.

18. The device for communicating useful information of claim 13 wherein the sensor senses RFID signatures.
